(19) United States
(12) Patent Application Publication
(10) Pub. No.: US 2005/0144074 A1
(43) Pub. Date: Jun. 30, 2005

(54) Computer implemented method and system for on-line redemption of coupons

(75) Inventors: Willard R. Fredregill, Lakeville, MN (US); Harold E. Schrum, Chanhassen, MN (US)

Correspondence Address: Schwegman, Lundberg, Woessner & Kluth, P.A., P.O. Box 2938, Minneapolis, MN, 55402, US

(73) Assignee: Carlson Companies, Inc.

(21) Appl. No.: 10/933,126

(22) Filed: Sep. 2, 2004

Related U.S. Application Data
(63) Continuation of application No. 09/724,558, filed on Nov. 28, 2000.

(51) Int. Cl. G06F 17/60

(52) U.S. Cl. 705/14; 705/40

(57) ABSTRACT

A computer implemented real-time consumer reward point accumulation system in which a consumer accumulates points immediately in a centralized data storage of a host incentive award system upon coupons being redeemed at an interactive web site that is networked to the host incentive award system. The coupons are redeemed by inputting consumer identification data and a unique coupon identification number acquired off of a coupon into appropriate fields on a web page of an Internet web site, optionally facilitated by the use of an electronic scanning device that scans the data from the consumer's program identification card and/or a printed bar-code on the coupon. Upon user engagement, the Internet web site transmits the consumer identification data and the coupon number to the loyalty program host system. The loyalty program host system queries the information received and locates a consumer award account record and a coupon record. The consumer award account record includes an associated consumer loyalty program point total, and the coupon record, associated with the unique coupon identification number, has the associated loyalty program award point total. The system immediately adds the associated loyalty program award point total to an initial consumer award point total retrieved from the consumer award account record and stores the revised point total in the centralized data storage in real time. The updated loyalty program point total is available for use by the consumer for Internet or in-store purchases at retailer outlets. The consumer experience at the web site is tailored to the consumer by leveraging the consumer's history of product purchases to provide promotional information specifically relevant to the individual consumer. The system further leverages the information regarding which promotions are specifically relevant to each consumer by optionally emailing the consumer with information about the promotions deemed relevant to the consumer.

### FIELD OF THE INVENTION

This application is a continuation-in-part of U.S. patent application Ser. No. ______, filed Feb. 18, 2000 by Willard R. Fredregill and Harold E. Schrum, entitled, “COMPUTER IMPLEMENTED METHOD AND SYSTEM FOR ON-LINE REDEMPTION OF COUPONS”.

This invention relates generally to a reward and redemption program. More particularly, the present invention relates to a reward and redemption program implemented by an award and redemption system that is linked via a communication network with merchant retail purchasing systems and includes the use of coupons. Such retail purchasing systems include point-of-sale computer systems of the type used in retail stores to perform sales transactions and allow for reward issuance and redemption; and on-line interactive web sites that provide personal computer users interactive award and redemption capabilities whereby coupons accumulated can be redeemed on-line, wherein the on-line experience may be enhanced by the consumer using a scanner to enter program or coupon information. The present invention is a complete reward and redemption program and system that allows retailer's that have in-store and/or on-line Internet shopping capabilities to build more comprehensive customer loyalty to product retailers and manufacturers by building loyalty with customers from awards distributed during customer in-store shopping and redeemable during customer e-commerce shopping and by extending customer loyalty by leveraging program activity data to customize certain marketing efforts on a consumer-by-consumer basis, including the user experience at web sites and system-originated promotion emails. Awards are distributed during in-store shopping by including coupons representing loyalty point awards in product packages. The loyalty point awards collected from product packages are redeemable at an electronic commerce site on an interactive web site.

### BACKGROUND

Traditionally, in a retail environment, retailers and manufacturers build customer loyalty to goods and services offered for sale through advertising and coupons. Many manufacturers distribute coupons for their products, either through the mail, by printing them in newspapers or magazines, or enclosing them in similar or related product packages. Presently, there are point-of-sale systems which assist manufacturers with coupon distribution by printing redeemable coupons at the point-of-sale terminal for immediate delivery to the customer. These systems are designed specifically for putting discount coupons for selected products in the hands of a customer who uses some competing product. Point-of-sale systems have also been combined with central computers to eliminate coupons and allow the consumer to earn awards at the point-of-sale in select retailer outlets wherein the awards earned are stored in a central data storage.

Another example of an award program using Internet/World Wide Web and browser technologies, is disclosed in U.S. Pat. No. 5,774,870 to Storey. The Storey patent discloses a fully interactive on-line frequency and award redemption program. The system disclosed in the Storey patent provides on-line access to product information, allows for product purchases using an electronic ordering form and provides award and redemption options using an on-line electronic redemption order form. As a result of the introduction of on-line frequency and award redemption programs, merchants that also have electronic storefronts and utilize traditional point-of-sale type loyalty programs are seeking ways to attract traffic and build customer loyalty to their electronic storefronts. Many of these merchants have established a presence in the physical marketplace with their retail outlets, and are implementing electronic commerce web sites on the Internet to augment and/or replace their physical retail outlets. A need exists for a single loyalty program with the capability to span both domains, such that a retailer participating in such a program has a competitive advantage in both the electronic commerce and the retail marketplace environments. Such a system should provide incentives to customers for items and services purchased at the point-of-sale and on-line at interactive web sites.

### SUMMARY

The present invention provides a computer implemented real-time consumer reward point accumulation system in which a consumer accumulates points immediately in a centralized data storage of a host incentive award system upon coupons being redeemed at an interactive web site that is networked to the host award system. The consumer reward point accumulation system is comprised of an on-line interactive web site networked to a host incentive award system. The on-line interactive web site is comprised of at least a web site processor, web site data storage that is electronically coupled to the web site processor, data input, which may include the use of a scanner to electronically enter the customer or coupon award information, electrically coupled to the web site processor for receiving coupon reward redemption requests and a web site communicator electrically coupled to the web site processor for transmitting coupon reward redemption request data to the host incentive award system. The host incentive award system is comprised of at least a host processor, centralized data storage electrically coupled to the host processor, and a host communicator. The centralized data storage includes a plurality of reward coupon data records, wherein each reward coupon data record includes data representative of at least a unique coupon number and an associated point reward. The host communicator is electrically coupled to the host processor and receives the coupon reward redemption request from the on-line interactive web site. The host processor processes each coupon reward redemption request to determine points awarded, and immediately updates a consumer award point balance stored in the centralized data storage by adding the points awarded to the consumer award point balance stored at the centralized data storage. The coupons used in association with the computer implemented system are included within or upon the packaging of products sold at a retailer's location. Each coupon has associated with it a unique reward coupon identification data, such as a unique number or other alphanumeric characters or symbols. The method of redeeming coupons through use of the present invention comprises the steps of inputting consumer identification data and the unique coupon identification data acquired off of the coupon into appropriate fields on a web page of the interactive web site, and transmitting the consumer identification data and coupon number from the Internet web site to the loyalty program host system. The inputting of some or all of the consumer identification data and unique coupon identification data may be done using a consumer operated data reader such as a scanner to automatically enter the data, or by manually entering the data. Point of entry of the coupon identification number is not important as long as the information is gathered. The loyalty program host system processes the transmitted information by querying the centralized database to locate a consumer reward record associated with the consumer identification data and to locate a coupon record associated with the unique coupon identification number input. The program host system further processes the transmitted data by immediately adding the associated point award data retrieved from the centralized data base to data representative of the initial consumer reward point total. The present invention further leverages the consumer information stored in the centralized data storage system to customize the consumer experience at the web site by providing promotional information specifically relevant to the customer at that point in time based on the consumer's history of product purchases and which promotions the consumer is close to qualifying for in light of the consumer's purchasing history. The program host system further leverages this consumer-specific advertising in the form of system-originated emails to the consumer, which highlight those promotions.

### BRIEF DESCRIPTION OF THE DRAWINGS

The invention may be more completely understood in consideration of the following detailed description of the invention in connection with the accompanying drawing, which are incorporated in and constitutes a part of this specification, in which:

FIG. 1 is a networking diagram illustrating the various computer components of the system in accordance with the invention;

FIG. 2 is a functional diagram illustrating system functions;

FIGS. 3a, 3b and 3c are flow charts depicting the logical flow of an in-store points redemption system in accordance with the principles of the invention;

FIGS. 4a, 4b is a flow chart illustrating an embodiment of the on-line enrollment process of the present invention;

FIG. 5 is flow charts depicting the logical flow of the shopping functions within the interactive Web site portion of the system in accordance with the principles of the invention;

FIGS. 6a, 6b and 6c is a flow chart depicting the logical flow of the purchase finalization function within the interactive web site portion of the system in accordance with the principles of the invention;

FIG. 7 is a flow chart depicting the logical flow of on-line redemption of a coupon at the interactive web site portion of the system possibly using the scanner portion of the system in accordance with the principles of the invention; and

FIG. 8 is a system flow that illustrates the chronological steps involved in creating a unique coupon identifier, manufacturing and packaging the coupon, distributing the coupon, redeeming the coupon, and invoicing the manufacturer appropriately based on the coupon's value.

### DETAILED DESCRIPTION

### System Overview

The principles of the present invention provide for a computer implemented on-line electronic consumer transaction point accumulation system in which a consumer earns points which are immediately reflected in a central location regardless of where the points are earned. The system that implements the present invention spans the physical and internet domains by providing a system where a consumer may earn points on transactions occurring in a retailer's store, at a retailer's internet based web site storefront, and at the loyalty program administration web site through redemption of coupons. The system allows points earned on transactions in either domain to be immediately reflected in centralized data storage. Use of the invention provides a plurality of different retailers which have established a presence in the physical marketplace to enhance their presence and consumer loyalty by providing a means for rewards to be earned in both the physical and internet domains. The rewards earned in both domains are all maintained on one system. No distinction is drawn between rewards earned in one domain in comparison to rewards earned in the other. The system provides merchants with the ability to develop enhanced consumer loyalty, loyalty above and beyond that provided by loyalty programs that span only the physical domain or the internet domain. Participating merchants may fall into one of three categories: (1) electronic commerce only, (2) physical store location(s) only, or (3) a merchant could having both a physical store location(s) and an electronic commerce web site on the Internet. Supported by a network of non-competing retail partners in both the physical and internet domains, use of the invention allows retailers to increase revenues and profitability by assisting in the retention of loyal shoppers and acquiring new customers.

The loyalty program implemented by a preferred embodiment of the system constructed according to the principles of the present invention, spans the physical and internet domains, wherein transactions occurring in the physical domain take place in retail outlets, typically at point-of-sale devices. Transactions occurring in the internet domain take place on consumer personal computers via a retailer's interactive web site, and may include the use of a scanner by the consumer. It is to be understood that retail outlets are meant to include any establishment from which a consumer may purchase goods or services, including stores, service establishments, catalog outlets and mail order houses. It is also to be understood that an interactive web site includes any internet based virtual store from which a consumer may purchase goods or services. In the physical domain, system functionality in each retail outlet is implemented by the in-store system controller, the point-of-sale device, such as a cash register, or through a service desk work station. The service desk is one point of entry into the system through which a customer may enroll in the program, redeem points for certificates, transfer points from one account to another, or have certain administrative functions performed. In the internet domain, system functionality at each web site is implemented by the web server processor, and may be complemented at the consumer end with a scanner used by the consumer to enter the consumer's loyalty program identification number.

To participate in the loyalty program in either the physical or the electronic commerce domain, the consumer must be identified by a unique account identification number. A unique identification number is assigned to a consumer participant during enrollment. There is no required enrollment period which must pass before a consumer may participate in the loyalty program. Consumers may enroll in the program through various methods, including a paper enrollment form provided at participating merchant locations, or via an electronic enrollment form on the electronic commerce merchant's web site, or via a program host web site maintained by the loyalty program administrator. Although enrollment at a merchant's store may be accomplished in various ways, the most common way consumer enrollment information is captured in the physical domain is by use of paper enrollment forms. When the customer completes a paper form, he or she is provided with a point accumulation card that is instantly usable at any one of the plurality of retail stores networked to the program administrator's host system. The account number identified on that card, which may optionally include a scannable representation of the account number, is also immediately accepted by any electronic commerce merchant participating in the program having a web site on the Internet. The merchant sends the paper forms to a data entry vendor, where they are converted to electronic form. The electronic data is then forwarded to the program administrator host system and added to the centralized customer database within the host system. Another source for enrollment data includes information gathered via applications for affinity credit cards. Enrollment data would be captured in electronic form and forwarded to the program administrator host system for entry into the central customer database.

Program enrollment data may also be captured over the Internet. If the consumer has already provided name and demographic data to the electronic commerce merchant for billing or shipping purposes, that information can be used by the electronic commerce merchant to populate the fields of an electronic enrollment form. If that information is not available, the participating electronic commerce merchant may provide electronic forms on their web site. The program administrator host system may also provide these electronic forms which may be accessed through the program administrator's loyalty program e-commerce web site. It is to be understood that the enrollment form could be accessed from the homepage within either the program administrator's loyalty program e-commerce web site or a participating merchant web site, or from other pages within either site. Point of entry is not important as long as the appropriate information is gathered. The user interface simply presents an electronic form and prompts the consumer to enter the information requested on the form. Upon completion of the form, or if the consumer information was obtained from existing data, the data is transmitted to the program administrator host system, and checked against various edit rules for validity. If the data passes the edit checks, the on-line point server within the program administrator host system creates a new account and assigns a unique account number to that account. Successful receipt of the enrollment data may also trigger an electronic response which may include transmitting an email message to the customer advising them of successful receipt of enrollment data and/or transmitting the program account number, which can be used immediately, in either the physical or internet domains for transactions during the consumer visit to a participating retailer outlet or retailer web site. The email message also informs the customer that the loyalty program card being mailed will enable the customer to earn and redeem points in either environment.

Consumers that enroll in the loyalty program are assigned a unique account number and provided with a permanent point accumulation card identifying that account for use in the physical domain at retail stores and service outlets whose point-of-sale equipment is programmed to read the account number from the loyalty point accumulation card. The point accumulation card may be a card having a read only magnetic stripe or bar-code positioned on the card. The bar-code or magnetic stripe includes data representing the customers account number. Upon activation of the customer's point accumulation program account, use of the point accumulation card prompts the system to search for the customer's point accumulation account. The card number, which is preferably sixteen digits, includes a persistent six digit ISO (International Standards Organization) number and a check digit.

Generally, the loyalty program implemented with the system works as follows. In the physical domain, each time a customer shops at a retailer store, during check-out or payment for items purchased, the customer's point accumulation card is swiped or scanned through a point-of-sale device magnetic card reader or barcode scanner. The device that reads account data from the point accumulation card is part of the system. The system reads the customer account number which is encoded on the magnetic stripe or bar-code and sends a request for retrieval of the customer award point balance which is linked to the customer account number. The system also includes the ability to handle late card presentation at the point-of-sale and an alternate form of account identification, such as a credit card or driver license number. If alternate account identification is presented by the customer, the system includes a mechanism to identify the customer and the customer account number from the alternate account identification information processed by the system so that a request for retrieval of the customer award point balance can be completed. One mechanism that can be used to identify the customer is to link the alternate identification (such as credit card information) to the customer primary account number. When such a link has been established, the host system processes the alternate identification sent by the point-of-sale device and locates the customer account by way of the link between the account number and alternate identification. The host system then sends the primary account number and account information to the point-of-sale device.

Following the request for customer account information, the program administration host system sends at least the customer's current accumulated award point balance from a centralized host system data base. The data received is stored at the point-of-sale device in temporary data storage and is displayed in real-time to the point-of-sale device. Similarly, in the Internet/electronic commerce domain, a customer may make purchases through the web sites of participating retailers. The retailer web site, having an interactive homepage, is networked to the host system via a direct connection to the on-line point server or via the program administrator loyalty program e-commerce web server. The retailer web site server queries the on-line point server and retrieves the customer award account point balance from the host system database.

Consumer transactions that occur via the internet domain assumes that a consumer has a device for accessing the internet, for example a personal computer with browser software, WebTv, mobile phone having internet access capabilities, PDA having internet access capabilities, etc. Optionally, the consumer may also have a device for scanning the consumer identification card. When a consumer accesses the Internet, that consumer may enter the URL (Uniform Resource Locator) address of the participating retailer electronic commerce web site and initiate the process to display contents of that “page” on their personal computer. The content corresponding to the primary URL is typically referred to as the “homepage” of that web site, which presents the user with information and a menu of features, displayed either as images or text having corresponding link to a new “page” of information. When a participating loyalty program customer accesses the web site of a participating retailer, the system provides the customer with an option to identify themselves as a participant in the loyalty program. In one embodiment, a customer may identify themselves by entering their loyalty program account number, and may be assisted by the use of a scanner used to scan the customer's identification card that identifies the customer. It is to be understood that use of the account number is only one method of identifying a participating customer and that the step of identifying a customer is not to be limited to the use of the customer account number.

If the loyalty customer is linked to the participating retailers web site via the loyalty program administrator's e-commerce web site, the loyalty program account number may be passed to the participating retailer's web site electronically. This omits the need to re-enter the loyalty program account number after it has been entered once at the program administrator's web site. The loyalty program account number may also originate from enrollment at any physical store location, the program call center, an affinity card or another participating electronic commerce web site. If the customer enters an account number after accessing the participating retailers web site, the number is verified against a check digit routine to validate correct entry and held in temporary storage for use in identifying that customer as a loyalty program participant. The account number may be verified against the central database from any point in the on-line consumer transaction process flow. The customer record stored at the central database is also accessible via the award program account identification number. This information may be used to customize the content and the “look and feel” of the web site for the customer. If the user accessing the web site does not enter an account number, or does not have a loyalty program account number, an option to enroll in the program and obtain an account number is offered to the user.

An additional feature that the system provides in the internet domain is to allow retailers to separately capture and store information about a user within their web site. This explicit information typically includes customer name and demographics, preferences, billing and shipping addresses, credit card data, user identification number, PIN number, etc. This data may also be used to help personalize the web site. Some of the explicit information captured can be used for alternate identification purposes if the customer does not know the award program account number. For example, a credit card number can be used instead of the program customer award account number. The system includes a mechanism to identify the customer and the customer account number from the credit card number processed by the system so that a request for retrieval of the customer award point balance can be completed. One mechanism that can be used to identify the customer is to link the alternate identification (such as credit card number) to the customer primary account number. When such a link is established, the host system processes the alternate identification sent by the web site server and locates the customer account by way of the link between the customer primary account number and alternate identification. The host system then sends the customer record information associated with the customer primary account number to the participating retailer web site.

Customers may earn points based on the pre-tax non-exempt purchase total for purchases conducted in at participating retailer stores/outlets and on-line through participating retailer web sites. The points that may be earned include “regular” points and “bonus” points. Any points earned, regular or bonus, are added to the customer's current award point balance stored in a centralized host system data base in real-time. Customers may also earn points on purchases conducted in participating retail stores by redeeming on-line coupons included within or on the packaging of items purchased in participating retail stores.

In the preferred embodiment, customers earn “regular” points based on the pretax dollar amount of the current sales transaction, less any exempt items. “Bonus” points are extra points that may be earned by the customer on the purchase of specially promoted items on the retailer web site or throughout the retailer outlet. Bonus points typically have a pre-set value defined on the item stored in the item master file. In the internet domain, the master file is stored on the web site server. In the physical domain, the master file is stored within the in-store controller. For example, if a specific manufacturer of mobile phone cigarette lighter adapters for use with a specific mobile phone has seventy five bonus points attached to it in the master file, a customer will be awarded seventy five points upon purchase of the item. Bonus points may also be awarded in a variable pricing scheme. One example of a variable points award pricing scheme is in the context of items that have variable prices based on the amount purchased or weight, such as fruits, candies, vegetables and meats which may award 50 points for each pound of an item purchased. “Bonus” points may be sponsored by the participating retailer, manufacturer or the program coordinator. The amount of “regular” points that may be earned on a sales transaction is dependent on the dollar amount of the transaction, whereby the calculation of “regular” points is skewed on a sliding scale to favor customers making purchases that total a larger dollar amount. An example of the manner in which regular points are awarded is shown below in Table 1. Not all consumer products are eligible for point accumulation. For example, exempt items which in some jurisdictions may be items such as tobacco and alcohol do not generate points when purchased.

As shown in Table 1 below, in one embodiment, the system is configured so that it has two “breakpoints” for point calculations. A breakpoint is the minimum purchase amount required to begin earning points. The first breakpoint in the embodiment illustrated is ten dollars ($10). The second breakpoint is twenty five dollars ($25). Twenty five dollars ($25) is an amount just above the current average transaction amount which triggers a higher point issuance rate. All cent amounts are truncated when calculating points. Although transactions less than the ten dollar ($10.00) minimum are not eligible for regular points, bonus points are awarded for any bonus items purchased even if the transaction amount is less than ten dollars ($10.00). At any given time, the average store may feature several hundred bonus items. It will be appreciated by those skilled in the art that the number of points, the various break points and the bonus items are representative of one preferred embodiment by a system implementing the principles of the present invention. Other point amounts, dollar amounts and products might be used and should not be construed as limitations of the present invention.

TABLE 1
Example

| Points are calculated based on the following criteria: | |
|---|---|
| Minimum purchase | $10 |
| First break point | 5 points per dollar ≧ $10 |
| Second break point | 10 points per dollar ≧ $25 |

| Purchase | First Break Points | Second Break Points | Total Regular Points |
|---|---|---|---|
| Amount | Awarded | Awarded | Awarded |
| $5.00 | 0 | 0 | 0 |
| $10.00 | 5 points | 0 | 5 points |
| $15.21 | 6 × 5 points | 0 | 30 points |
| $25.00 | 15 × 5 points | 1 × 10 points | 85 points |
| $30.99 | 15 × 5 points | 6 × 10 points | 135 points |

The example shown above in Table 1 illustrates the manner in which points are accumulated in one embodiment. In the above example, the amount of the customer's purchase must be at least ten dollars ($10) in order for a customer to earn any regular points. If the purchase price of all items purchased is greater than or equal to ten dollars ($10), the customer will earn five points per dollar amount purchased up to, but not including the second break point at twenty five dollars ($25). Once the total purchase value reaches twenty five dollars ($25), in addition to the five points being earned for each dollar between $10 and $25, the customer earns ten points for each dollar beginning with the twenty fifth dollars ($25).

As shown in Table 1, if the purchase amount is equal to five dollars ($5.00), no points are awarded. If the purchase amount is at least equal to ten dollars ($10.00), five points are awarded. No points are awarded for purchases that are less than ten dollars. If the purchase amount equals fifteen dollars and twenty one cents ($15.21), thirty (30) points are awarded: five points are awarded for the first ten dollars ($10) and five points for each dollar above ten dollars ($10) for a total of 30 points. No points are awarded for the twenty one cents because all cent amounts are truncated when calculating points. If the purchase amount is equal to thirty dollars and ninety nine cents ($30.99), one hundred thirty five (135) points are awarded. Five points are awarded for the first ten dollars ($10) and for each dollar above ten dollars ($10) for a total of seventy five points. The seventy five points are characterized as first break points. Because the total purchase amount is greater than twenty five dollars ($25) the customer earns second break points which are ten points for the first twenty five dollars ($25) and for each dollar above twenty five dollars ($25) for a total of 60 points. No points are awarded for the ninety nine cents. The total points earned for a purchase that totals thirty dollars and ninety-nine cents ($30.99) as shown above in table 1, is one hundred thirty five points (135) by virtue of combining the first and second chance break points.

Customers may redeem the points earned when purchasing a redeemable item in a number of ways, including gift certificates and/or catalog items at the retailer service desk, or at the time of such purchases for both on-line and in-store purchases. On-line redemptions occur through a participating retailer's interactive web site and in-store redemptions occur through a point-of-sale device. However, in some embodiments of the system, a customer may not be allowed to redeem points earned on a redeemable item until certain information has been input into the system. For example, a retailer may want demographic information input into the customer record of each customer prior to allowing each customer to redeem points in the program. The retailer could implement this requirement by placing a block on each customer's redemption of points until the demographic information has been input into the customer record. In the physical domain, a customer would be directed to the retailer service desk so that the customer profile data required could be input and stored in the customer record at the host system. In the internet domain, the web site server queries the customer for the customer profile information. In one embodiment, entry of the requisite profile data is used as a prerequisite to the customer using the account. In this embodiment, upon entry of the requisite consumer profile data, the web site server analyzes the consumer transaction point data to determine if the data representative of the consumer transaction point balance is greater than or equal to a cash credit point balance. In other embodiments, the web site server analyzes the consumer transaction point data after the account has been established and prior to entry of the requisite profile data. Where the consumer transaction point balance is greater than or equal to the cash credit point balance, the consumer is provided with an option to immediately reduce the price of a redeemable transaction item by a specified amount.

The redemption of points at the service desk for catalog items, certificates, and certificates for travel-related awards that may be redeemed at a variety of point levels, are validated against the customer account at the centralized host system database, and the customer's point balance reflected in the account is debited in real-time upon redemption of points for certificates or catalog items.

The redemption of points during conclusion of on-line purchases or at check-out for purchases occurring in a retail store, in one embodiment, occurs against all items purchased. In this embodiment points are redeemed against the overall purchase price of a customer's transaction. Redemption of points reduces the cost of all items purchased during an online visit or at the end of the check-out process for purchases occurring in a retail store. In another embodiment, the redemption of points during conclusion of on-line purchases or at check-out for purchases occurring in a retail store may only occur for items that are specifically designated as redeemable. Items are designated as redeemable by the retailer. A customer who purchases an item designated as redeemable will be notified of the item's eligibility for redemption by the retailer. In some embodiments, depending upon capabilities of the web site server and point-of-sale systems, the retailer system may notify the customer of the item's eligibility for redemption after the item has been input into the retailer system as one being purchased. If the customer decides to redeem the item eligible for redemption, points will be debited from the customer's account award point balance and the customer will receive a reduction in the price of the item being purchased immediately. The system also includes the ability to reflect additional reductions in the price of items purchased by customers participating in the loyalty program. Such reductions are determined by the individual participating retailers. For example, all customers that enter their account numbers into the retailer system during transactions can be given cents off discounts of any amount for a transaction item identified by the retailer. This additional reduction in price can be given separately or in combination with the price reduction that is provided by the redemption of points on selected redeemable items.

An example of the additional reduction in price utilized in combination with a standard point redemption can be visualized on a redeemable item priced at two dollars ($2.00). If the retailer desires to give away the redeemable item at no cost to the consumer, the retailer may assign an additional reduction amount of eighty cents to the redeemable item. When a customer presents the award account number card along with the purchase of the item, they would get an eighty cent discount and if they choose to redeem the item, they could exchange 750 points for a reduction of $1.20 and get the item for free. In this scenario, the additional discount is not dependent upon whether the customer redeems points for a reduction in price. Any customer that participates in the program and enters an account number into the retailer system during the purchase of products or services would get the reduction in price. It is also contemplated that the additional discount could be dependent on redemption of points. Wherein, the additional reduction in price of eighty cents will not occur unless the customer elects to redeem points for an initial reduction in price.

In the physical domain, during customer check-out at the point-of-sale device, the system prints on the sales receipt bonus item descriptions and the corresponding bonus points earned for all bonus items purchased during the customer's visit to the retailer. Redemptions taken by the customer at the point-of-sale are also printed on the receipt. When the customer completes all transactions, the system calculates and prints on the customer receipt the total points earned for those transactions and the new award account point balance which reflects all points earned and redeemed during the present visit to the retailer. The system also transmits a message carrying the total points earned in the transaction by point category and the total points redeemed in the current transaction to the centralized host system database at the completion of a transaction so that the customer account can be updated. At the retailer's option, the system allows for the retailer to create a transaction log file that is configured to capture and upload information about customer transactions at various levels of detail for data analysis. The transaction log file is generated at both types of retailer systems for transactions occurring on-line and in-store.

Consumers that have a loyalty program account number use the program administrator's interactive web site for a variety of activities, including the coupon redemption of coupons received off the packaging of purchased products or enclosed in the product packaging. The present invention may additionally provide the consumer with a customized experience at this web site by leveraging the promotional information and the consumer's specific product purchasing habits. The promotional data in the operational database host system is cross-referenced and compared to the data regarding the consumer's purchases to see which promotional offers are the most relevant. This includes, without limitation, those the consumer is close to satisfying, or those established to encourage the consumer to buy new products that have been demonstrated demographically to appeal to consumers who have purchasing habits similar to the specific consumer. These offers are highlighted on the web site, promoting more comprehensive customer loyalty to product retailers and manufacturers by specifically bringing relevant promotions to the consumer's attention based on analysis of the consumer's history of purchasing.

The present invention further leverages the information concerning which promotions are the most relevant to a given consumer by providing the mechanism to email the relevant promotions to the consumer. In this way, a consumer-specific marketing effort can be directed at each consumer in a way that is most appropriate and tailored to the individual consumer, in both a passive way, when the user comes to the administration web site to redeem coupons, as well as in an active way, using system-originated email notification of the same promotion information.

### DETAILED FUNCTIONAL DESCRIPTION

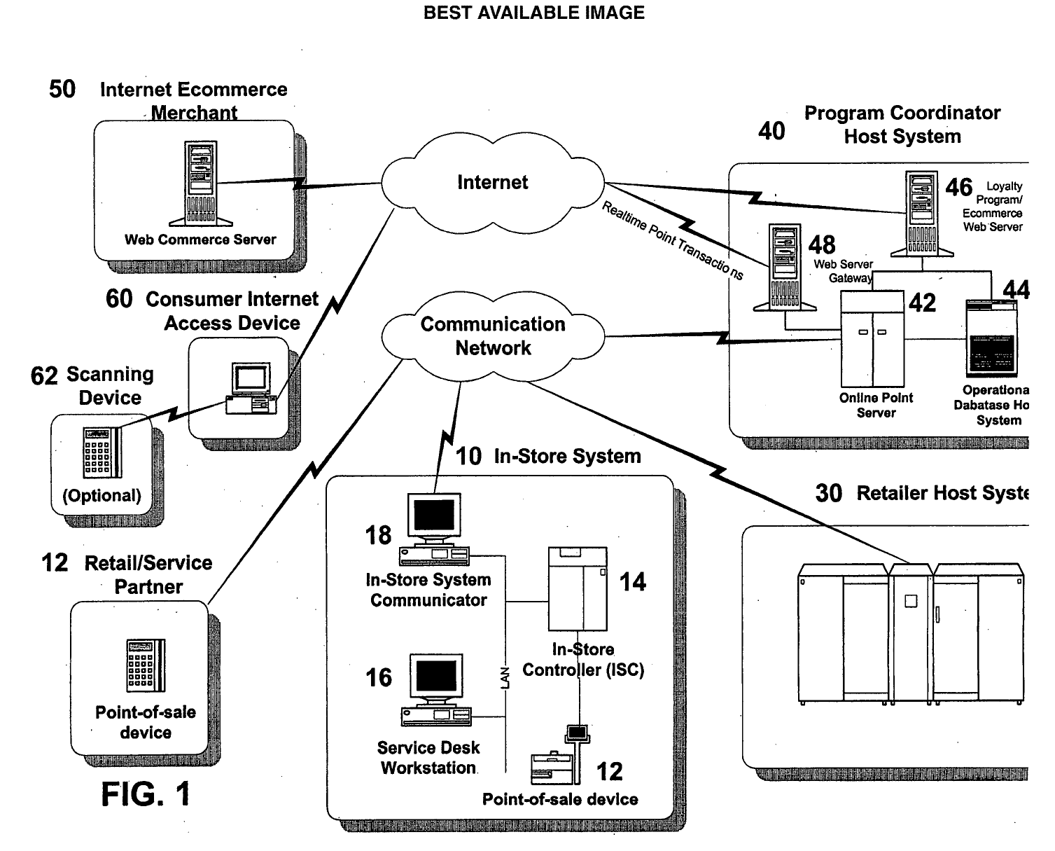

FIG. 1, shows a diagram of an embodiment of the computer implemented consumer transaction point accumulation system. The system includes retailer systems comprised of an in-store system 10 in communication with a retailer host 30 and a merchant web site server 50 in communication with a consumer internet access device 60, which is electronically linked to a scanning device 62 in some embodiments. The system also includes a program coordinator host system 40. The in-store system 10 is comprised of a general retailer point-of-sale device 12 that includes a magnetic card reader and/or bar code scanner. It has on-line connectivity to both the program coordinator host system 40 and the retailer host system 30. The point of sale device 12 is electrically coupled to an in-store controller 14 that is electrically coupled to an in-store system communicator 18. In other embodiments, the system does not include an in-store system communicator 18 and the in-store system controller 14 performs the function of transmitting and receiving communications from the program coordinator host system 40. The program coordinator host system 40 is comprised of an on-line point server 42, a central database host system 44, a loyalty program e-commerce web server and a web server gateway 48. The in-store system 10 may also include a networked workstation 16 that is utilized at the retailer service desk. The in-store system communicator 18 and the service desk work station 16 routes the transactions of the in-store system to and from the program administrator host system 40 via a communication network. The transactions being routed between the in-store system 10 and the host system 40 occur in real-time.

The in-store system's retailer host system 30 is electrically coupled to the in-store system controller 14. The retailer host system 30 facilitates centralized setup of program data related to bonus and point-of-sale redeemable items. The retailer host system 30 transmits the set-up details for bonus and point-of-sale redemption items to the point of sale devices at each retailer outlet through the in-store system controller 14. Although the majority of the setup data is received in batch from the retailer host system 30, which may be off-site, it may be necessary for store personnel to correct and/or modify set-up details downloaded from the host. A mechanism to read and change item level point parameters is thus a requirement at retailer level. Such changes are usually performed by accessing the in-store system controller 14 database. The retailer host system 30 also provides the retailer with the ability to batch upload customer activity shopping data for analysis.

In the present embodiment, the merchant web site server 50 has a web server processor, web server data storage electrically coupled to the web server processor, data input electrically coupled to the web server processor for receiving data transmissions from the consumer internet access device 60. The merchant web site server 50 also includes a web server communicator that controls communications over the internet between the web server and the consumer internet device 60 and communications over the internet between the web server and the program coordinator host system 40. Additionally, the web server communicator may offer communication to the retailer host system 30. It is to be understood that the merchant web site server disclosed in the present embodiment may have alternative configurations in other embodiments. The configuration of the merchant web site server 50 disclosed in the present invention is not intended to limit the myriad of different configurations the merchant web site server 50 may be implemented with.

The service desk work station 16 comprises a personal computer running a software application that allows a retailer to access the program coordinator host system 40. The retailer may access the application controlling the system and perform a number of functions depending on the levels of security attached to the function and the retailer employee's security clearance level. The functions available for access from the service desk work station 16 include: balance inquiry, transfer points, point balance adjustments, point refund, certificate issuance, merchandise order, add/change alternate identification, cancel/reissue customer card, enter enrollment data, and modify enrollment data. The service desk workstation 16 also transmits information regarding new customer enrollment changes to the central database host system 44. Alternatively, the service desk work station 16 could access a central database host system via the internet or an intranet. Similarly, a retailer may access the application controlling the system via the internet through use of a consumer internet access device 60. That connection may be achieved through the loyalty program e-commerce web server 46 or the program administrator host system web server gateway 48. If the application controlling the system is accessed, the retailer may perform a number of functions depending on the level of security attached to the function and the retailer employee's security clearance level. The functions available to a retailer accessing the system via the internet include: balance inquiry, transfer points, point balance adjustments, point refund, merchandise order, add/change alternate identification, cancel customer account, enter enrollment data and modify enrollment data.

The balancing inquiry function provides the customer with a current account balance. The transfer points function allows the retailer to assist customers in consolidating points between two customer accounts. The point balance adjustments function provides retailer personnel with the ability to make corrections to the customer's point balance in the customer's award account. The point refund function provides the retailer with a mechanism to recover points issued on merchandise returns.

The certificate issuance function allows the retailer to issue certificates to the program customers to be used at participating retailers. The certificates are printed with pre-assigned serial numbers in specific dollar amounts. When certificates are physically distributed to retailers, the host system 40 logs the serial numbers sent to each store and flags each certificate with a status “D” indicating that the certificate is distributed and eligible for issuance. At the time of issuance, the certificate serial number is entered at the service desk work-station 16 and verified through the on-line point server 42 to determine the status and value of the certificate. In order to be issued, the status flag for the certificate number being issued must be in the “D” state on the on-line point server 42. When the certificate is issued, the customer account is debited by the number of points necessary to purchase the certificate and the status flag for the certificate is changed to “I” on the on-line point server 42 indicating the certificate has been issued. The status flag assists with assuring that the certificates are used only once for face value.

When a certificate is being returned for redemption in exchange for a reduction in the price of a transaction (for example a $10 certificate for a reduction of $10 off the price of merchandise), the cashier or customer must input the serial number of the certificate into the participating retailer system 10, 50. Following entry of the serial number, participating retailer system 10, 50, which is electrically coupled to the on-line point server 42, sends a request to the on-line point server 42 to determine whether the certificate presented is an issued and redeemable/valid certificate. The on-line point server 42 validates the certificate by indicating that the status of the certificate is (“I”) issued and outstanding and that the certificate has not been previously redeemed. The retailer may redeem the certificate once an approval message is sent to the participating retailer system by the on-line point server 42. The retailer may then reduce the amount due on a purchase by the face value of the certificate. A certificate that is redeemed has its status in the on-line point server 42 immediately changed to (“R”). The redeemed status takes the certificate out of circulation and prevents the certificate from being used again.

The merchandise order function provides the retailer with the ability to assist the customer in redeeming points for catalog items. When the customer seeks to purchase catalog items, the customer account is verified through the on-line point server 42 to insure that the customer has a sufficient point total in order to redeem a specified catalog item. If the customer account has sufficient points, the point total is debited in real-time by the number of points necessary for purchase of the selected catalog item. The add/change alternate identification function allows for substitute identification numbers to be set up and modified. The canceled/reissued customer card function allows a retailer to close an existing customer account and transfer the points and customer information to a new customer account. The enter enrollment data function allows the store to enter demographic information for new program participants into the central data base host system 44. The modify enrollment data function allows the store to change demographic information for participating customers.

The in-store system controller 14 communicates directly with the in-store system point-of-sale devices 12 and transmits data files that define the items for sale at the retailer outlet as being bonus, exempt or redeemable. Bonus item, redemption item and exempt item data is transmitted from the retailer host system 30 to data storage files within the in-store system controller 14 for updating the in-store system controller data files relating to bonus, redemption and other system data. The in-store system controller 14 may also perform end-of-the-day processing at the local level which transmits daily totals to the on-line point server 42 for reconciliation. Upon receiving acknowledgment from the on-line point server 42 that the totals record was successfully received, the system controller 10 may extract customer activity and upload customer files to the central data base host system 44. This function also advances the in-store business date.

The on-line point server 42 serves all requests for point balances, updates and redemptions in both the physical and internet domains. The on-line point server 42 maintains a customer file that includes a plurality of consumer records for each customer participating in the point-accumulation system program. The customer account file also includes a plurality of merchant records for each of the plurality of non-competing retail merchants that support the program. Each customer record has the customer account data for each participating customer which includes data fields for storing at least the customer account number, the customer's total accumulated point value and customer profile information. The merchant records include at least transaction activity information.

The on-line point server 42 stores detailed point activity data for a current business day in a transaction log file. The on-line point server 42 also extracts and transfers all relevant data to the central database host system 44 for batch updating on a nightly basis. The on-line point server 42 maintains each transaction log file until the operational database 44 server returns a renewal file to the on-line point server 42 at which point the on-line point server executes a renewal process which updates the on-line customer database and purges the corresponding transaction log file.

The operational database host system 44 also serves as a master data repository to service other requirements for data (i.e., help desk, accounting, reporting, etc.) in support of the on-line point server 42, in both the physical and internet domains. In addition, the operational database host system 44 services all requests from the in-store service desk and the retailer web commerce server to add and modify customer demographic data. On a nightly basis, the operational database host system 44 receives the transaction log file extract file from the on-line point server 42, updates the appropriate tables on the operational database host system 44 and creates a renewal file. The renewal file is transferred to the on-line point server 42 to facilitate synchronization of the two-customer databases within the program coordinator host system 40. The system includes the capability to perform a full file audit to make sure that the two-customer databases are synchronized.

Another of the services the operational database host system 44 may support is the use of system-originated emails to the consumer regarding relevant promotions for the consumer. The program coordinator host system 40 periodically cross-references the available promotions against the purchasing history for each consumer, resulting in a list of promotions that are maximally relevant for the individual consumer, based on rewards that are believed to be realistically achievable by the consumer. The consumer is then notified via email regarding the relevant available promotions. Those skilled in the art will appreciate the value of tuning the heuristics used in applying the promotions that are maintained by the merchant 236 so that each consumer is notified of only those promotions that are actually relevant to that specific consumer. This analysis frequently involves, without limitation, demographic analysis wherein recognized consumers of brand A product A1 are believed to frequently desire brand B product B1. Knowledge of this kind allows the system to proactively notify consumers of A1 of the existence of promotions regarding B1 in an effort to get the consumer to try B1. Other promotions may be driven directly from the consumers purchasing history, as in the case of “buy 3 get 1 discounted”, in which case consumers who are recognized as having purchased 2 may be notified of the inherent value of purchasing additional product.

The retailer host system 30 and the merchant web site server 50 is where a majority of the setup data regarding bonus, redeemable and exempt items is entered. In the present embodiment, the retailer host system 30 transmits such setup data to the in-store system controller 14 at each retailer outlet for use during consumer transactions. In another embodiment, the retailer host system 30 transmits such setup data to the merchant web site server 50 for use during consumer transactions. The retailer host system 30 and the merchant web site server 50 perform at least the following item setup functions: exempt item setup, bonus item setup and daily item setup processing. The merchant web site server 50 also performs the function of on-line interactive redemption setup. The retailer host system 30 also performs the functions of in-store redemption item setup. The retailer host system 30 also receives the transactional log files from the in-store system controller 14 and service desk 16. The retailer host system 30 may also receive transactional log files from the merchant web server 50. Some transactional log files may also be transmitted to the program administrator host system 40.

The exempt item setup function defines the items and departments where the program points cannot be awarded. Information regarding exempt items is maintained on the merchant web site server 50 and the retailer host system 30. In the present embodiment, for the in-store system transactions in the retailer outlet, this information has to be downloaded from the host system 30 to the in-store system controller 14 database. In another embodiment, the retailer host system 30 transmits information regarding exempt items to the merchant web site server 50 for use during consumer transactions. Although it is not a requirement, in this particular embodiment, bonus item setup processing assigns a positive point value to an item and may also assign a start/stop date that defines the period during which an item maintains bonus status. Bonus item setup processing also identifies the sponsor of the bonus points—the retailer/merchant, the program coordinator, and manufacturer. This information is maintained on the merchant web site server 50 and the retailer host system 30. Information regarding exempt items is also downloaded to the in-store system controller 14 database for use at each individual retailer outlets. The redemption item setup function assigns a negative point and dollar value to an item and a start/stop date that defines the period during which an item maintains redemption status. In this particular embodiment, the point value for redeeming a redemption item is −750 points. The reduction of the price of the redeemable item is −$1.20, assuming the item purchased has a price that is greater than or equal to $1.20. This information is maintained on the merchant web server 50 and the retailer host system 30. For the in-store system transactions in the retailer outlet, this information has to be downloaded into the in-store system controller 14 from the retailer host system 30. The retailer host system 30 also performs end-of-day processing which extracts all customer activity from each store by retrieving the transaction log files from each in-store system controller 14 and service desk 16 at each retailer location. These files of daily activity are uploaded to the retailer's host 30 and/or to the central database host system 44. It is to be understood that the loyalty program e-commerce server 46 may also perform end of the day processing in a manner similar to that of the retailer host system 30. The retailer host system 30 and the loyalty program e-commerce web server 46 also provides for batch communications of collected data to the host system 40.

Processing of transactions that occur in either the physical or internet domain may be performed in two modes, one-phased or two-phased. Both modes of processing, one-phased and two-phased, occur in the internet and physical domains on the in-store system 10 and web site server 50. A one-phased transaction is one in which the in-store system or web site server 50 communicates once with the host system during the customer's transactions. The one-phased communication is the request and authorization for a point update transaction where the opportunity for point redemption is not selected. A two-phased transaction is where there is an automatic balance inquiry at the beginning of the transaction and a point update at the end of the transaction.

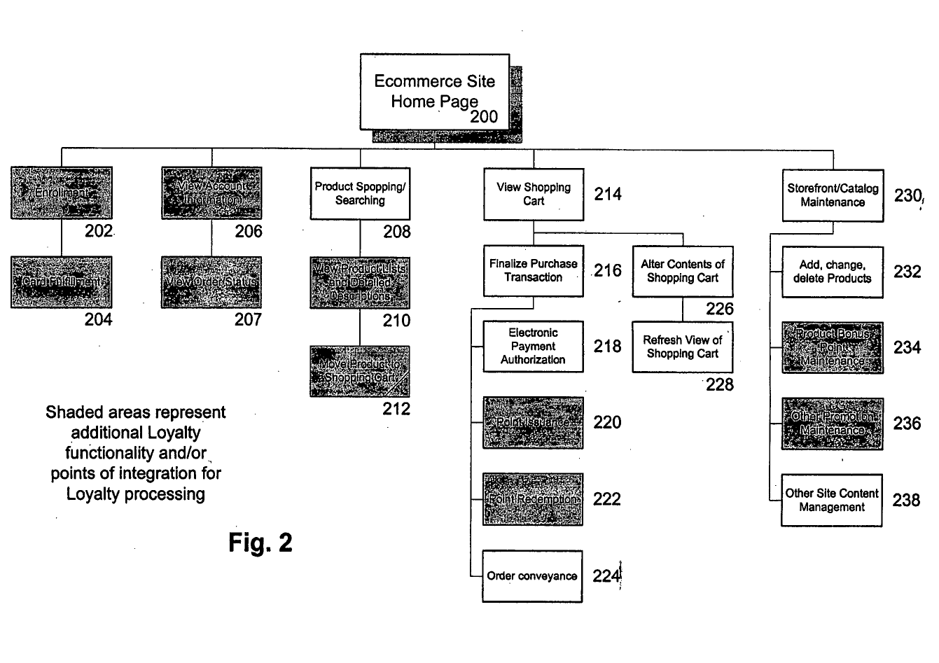

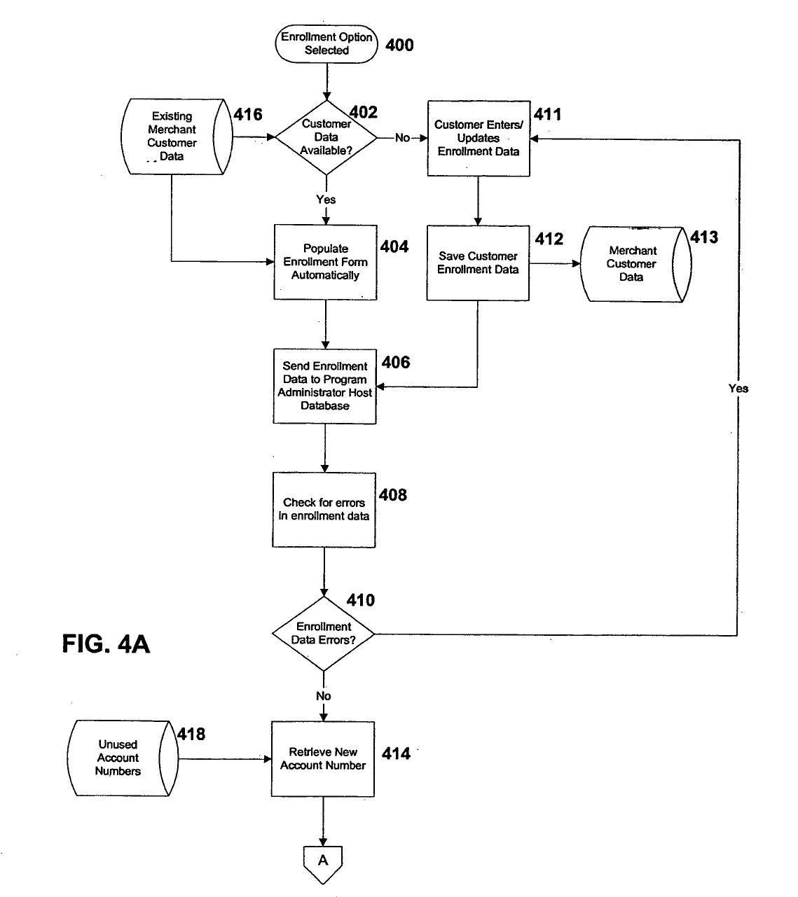

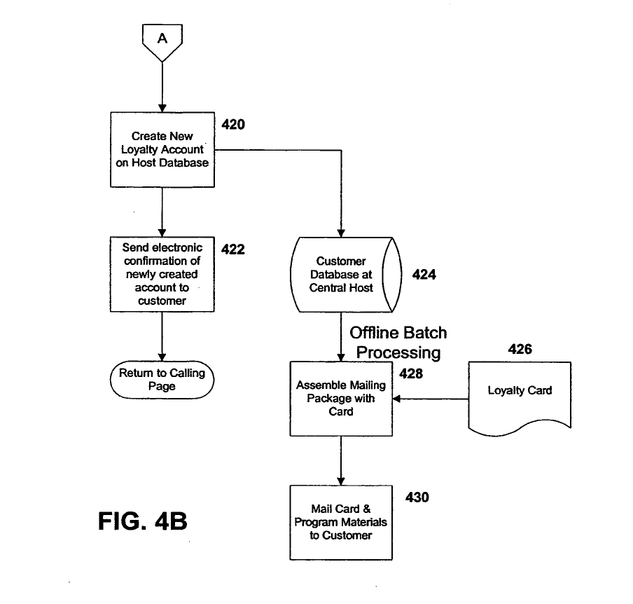

FIG. 2 illustrates the numerous functions that can be performed by the system through the on-line interactive web site 200 of a merchant. The enrollment function 202 (further described in FIG. 4) is typically performed through the use of electronic forms on the interactive merchant web site 50, or on the loyalty program e-commerce web server 46. The web site user interface simply presents an electronic form, and prompts the consumer to enter the information requested on the form, which may be facilitated by the use of a scanning device 62 when accessed via the consumer internet access device 60. Upon completion of the form, or if the consumer information was obtained from existing data, the data is transmitted to the program administrator, and checked against various edit rules for validity. If the data passes the edit checks, the central data base host system creates a new account and assigns a unique account number to that account. In the present embodiment, the creation of the new account may also trigger a card fulfillment process 204 implemented by the program administrator. This process physically extracts and matches a loyalty program card (typically plastic) with the correct account number assigned to the customer. The card is inserted into a mailing piece with other program materials and sent to the customer via the postal service. It is to be understood that the card fulfillment process may occur at any time during or after the enrollment process and may be triggered by a number of different functions or events.

Transactions through the merchant web site on the present invention also provide the program participants with the ability to view their individual loyalty account information through a view account information function 206. Within the view account information function, there are a plurality of optional methods of viewing account information. One method is a “Balance” option. The “Balance” option formats a point balance inquiry transaction and transmits that request to the program administrator host system for processing. The program administrator host system would query the award point balance associated with that account and return that information to the customer, via the merchant web site which displays the account balance to the consumer. Another method is the “Account” option which similarly formats a request for consumer loyalty program account information, and transmits the request to the program administrator host system. The on-line point server 42 and the operational database host system 44 within the program administrator host system processes the information retrieved via the web server gateway 48, which may include the enrollment data, the status of the account, and any other information deemed relevant to the account—lifetime points earned, etc. A further method is the “History” option which queries the program administrator host system and displays at the web site a transaction history for the requesting consumer account, describing recent transactions for the consumer account in summary form. The history description may include transactions conducted via the Internet as well as commerce transacted via the physical domain in retail network of stores at the point-of-sale device or service desk. For each loyalty transaction, the information provided may include the date and time of the transaction, name of the merchant, purchase amount, and points issued and/or redeemed. Another optional method is the menu option called “What's this?”, or “About (loyalty program name).” This option, if selected, transfers the user to a page with content describing the features and benefits, terms and conditions, and any other relevant information pertaining to the loyalty program. This could be a page within the merchant's web site, or a link to the loyalty programs e-commerce web server. Program participants are also provided with an option to view the status of their orders by selecting a view order status icon 207.

The primary function of the merchant web site 200, is the product Shopping/Searching function 208. Electronic commerce merchants maintain a master file of products available for purchase, and the electronic commerce application resident on the merchant web site provides an interactive homepage with several options for viewing and searching product information. The interactive homepage may display products alphabetically, by category or manufacturer, or the homepage could offer a search feature allowing the customer to find information based on various criteria, such as price, product manufacturer, product subcategory, SKU #, size, color, keyword, etc. Note that this function could be accessed in various ways from the homepage of the interactive homepage, depending on the business requirements and the merchant's preferences, including the use of a scanner to scan identification data of a product for which the consumer wishes to search. Regardless of what method the user utilizes to locate a particular product, an option to view a detailed description of the product is typically available 210. If the merchant offers bonus points for purchase of the item, that information would also be displayed in the detailed view of the product. Similarly, if a special discount is available on that product in exchange for the redemption of points, that information may also be displayed, along with event information, such as the effective dates of the special offer.

If the consumer visiting an interactive homepage on a merchant web site decides to purchase a product, an electronic “order form” may be displayed to gather the additional details of the order, such as quantity of items, size, color, etc. When the order form is complete, the user interface provides an option, via a visual control, to move the designated items to a storage area of memory known as the “shopping cart” 212. The “shopping cart” function displays the designated items currently placed in the “shopping cart”, along with pricing information for each designated item. Bonus points may also be attached to each designated item placed in the “shopping cart”. A running monetary cost subtotal may also be maintained and displayed for each designated item. In the one embodiment, an additional function, caused by placing an item in the “shopping cart”, is the triggering of an electronic point balance request to the program administrator host system, which in turn retrieves and transmits information representative of the award point balance back to the homepage where it is displayed to the consumer on his or her personal computer via the merchant web site. This provides the consumer with information useful in making purchase and redemption decisions. The consumer can determine if a sufficient award point balance is available to purchase a particular product outright through redemption of, or if a partial discount in exchange for a point redemption makes the proposed purchase feasible. Note that the point balance inquiry function could be triggered by other events in the shopping process, such as when a category or brand is selected or when a consumer logs onto the merchant web site server 50 or onto the loyalty program e-commerce web server 46. Note that the timing of balance inquiries performed by the balance inquiry function is not critical, as long as it is performed prior to the process invoked to finalize the purchase. Note that this point balance would include any points earned at other participating merchant partners in either the electronic commerce domain, or in the physical store domain. After the item has been moved to the shopping cart 212, the user is normally provided with the options to continue viewing the products available, view the contents of the shopping cart 214 and alter the content of the shopping cart 226. As the user continues to shop, the preferred embodiment displays the beginning point balance and a running summary of the total bonus points and “regular” points accumulated in the current transaction, and the projected new balance if the consumer purchases the items currently in the shopping cart. As the contents of the shopping cart are modified, the point information is updated to reflect those changes 228.

A unique feature provided by the on-line interactive web site of the present invention is the function that provides the merchant homepage manager with the option to alert a consumer visitor of the web site that is not identified as a program participant of the awards available to him or her should they choose to participate in the loyalty program. The alert could be in the form of a message reflecting the number of points that could be earned on that product or a special discount available only to program participants. Another example might include merchant partner offers available only to members at other participating program merchants. The merchant partner offers advertised could be other electronic commerce merchants, physical retail merchants, or both.

The shopping cart view of the user interface typically displays a visual control to provide the user with a means of indicating they are ready to place an order and finalize the purchase 216. When the user completes that action, typically by clicking the button presented on the user interface, the web site processor calculates and displays the total monetary amount due, including sales tax due and shipping charges. Prior to adding the shipping charges into the amount due, the customer is prompted to select the method of shipment, and once selected, the shipping charges are displayed and added to the total monetary amount due. Information representative of a summary of total points earned in the order is also displayed. A portion of the user interface displays an additional electronic form that provides the customer with an option to redeem points in exchange for a discount on the order. The redemption of points is not necessarily related to any specific item within the order. It is to be understood that various methods and rules for redeeming points may apply, at the discretion of the program administrator and the merchant. Information representative of the number of points needed to pay for the order in total, may also be available to the user. Also, information representative of a minimum point redemption amount may be specified, along with information representative of the fixed increments of points available for redemption. For example, the merchant may specify a 5000 point minimum redemption and may also specify that points are redeemable in blocks of 5000 points, up to the total amount due for the order. When the customer enters the number of points to redeem into the form, that amount is checked against the point balance previously retrieved. If the point balance was unavailable, the customer is not allowed to redeem points. If the customer has a sufficient point balance to honor the redemption request, a debit to the point account is prepared for transmission to the program administrator host system by the web site processor, and the total amount due is updated to reflect the reduced monetary amount due. If the customer does not have a sufficient point balance to honor the request, the user is informed of that condition and provided the opportunity to redeem a lesser number of points, or to proceed with finalizing the order without a point redemption. At this point, the merchant web site processor prepares and displays a point update message. The point update message informs the user that information representative of point credits, point debits, bonus points, merchant ID number and customer ID number is complete and ready to send to the program administrator host, pending positive approval of the transaction by the payment authorization service.

Once the combination of points and currency has been determined, the merchant web site processor prepares an electronic payment authorization message that includes information representative of the dollar amount due for transmission to the credit or debit authorization service with whom the merchant has a contract for service. The user's credit card information may be extracted from a profile held by the merchant. If such information is extracted, the customer is provided with an opportunity to validate that credit card number, or to enter in a different credit card number. Note that this profile may also include additional billing and shipping information that may be displayed by default on the electronic form, and altered by the user. If a profile for a user is not available, a form is presented to accept input of credit card information, and that information is validated by the merchant's electronic commerce application. The billing and shipping information may also be collected via a form. if unavailable via a profile. Once the credit card information, billing and shipping information is complete, a payment authorization request 218 is transmitted electronically to the credit/debit authorization service and validated by that system. The merchant electronic commerce application processes that response, and if the response was positive, proceeds with processing of loyalty point information by way of issuing and/or redeeming points 220, 222 and product ordering 224. If the payment authorization was negative, the user is informed of this condition and provided an opportunity to enter a different credit card number or to exit or postpone the transaction. Note that as part of the finalization process, the merchant also may invoke authentication routines to validate the purchase against shipping and/or billing information.

If the electronic payment authorization process resulted in a positive response, the merchant web site processor transmits the point transaction information to the program administrator host system. The host system will update the customer profile in the central database host system and respond to the merchant web site processor. The merchant web site processor may cause the display of a summary of the point activity to the customer following point balance update, the summary includes information representative of the beginning point balance, regular points earned, bonus points earned, points redeemed and the new point balance. As the consumer account information stored in the central database host system is updated with this information, note that this updated consumer account information is immediately available to all other retailer systems in both the physical and internet domains for participating merchants having retailer systems networked to the host system. An acknowledgement from the program administrator host system is not necessary for the web site processor to proceed with subsequent processing, and those skilled in the art will recognize that if the connection to the program administrator host system is unavailable for any reason, the transaction may be temporarily stored in web site server data storage until the connection is available, at which time the point update message may be re-transmitted.

To complete the order process, the merchant may also transmit the complete order to the supplier or suppliers, and manage the merchandise fulfillment process throughout the lifecycle of that process. The merchant may also fulfill the order from internal inventory. In the preferred embodiment, the product order 224 is automatically transmitted electronically to the order fulfillment entity, which could be an internal or external system. If the vendor is external, one method of communicating this information in the present embodiment is via a standard EDI (electronic data interchange) process or XML orchestration process (such as one corresponding to the BizTalk or ebXML Frameworks); alternatively, the method of communicating this information may be through batch processing or manually via other methods such as fax, email, or by printing a paper order and mailing it via the postal system. Once these product order processes are complete, the current transaction is complete, and the user may be returned to whatever page within the web site the merchant has programmed the web site processor to return the user to.

Integration of the loyalty program into the on-line interactive web site requires functionality to assign the rules for issuance of points, and a mechanism to assign bonus points to particular items, to particular purchase levels, to combinations of items, and so on 234. A merchant having an on-line interactive web site typically has a system to manage the content of the site 238, promotional offers 236, advertisements and to maintain the item catalog 230 as items are added, changed or deleted 232, and to manage pricing of those items. Assignment of bonus points is integrated into the item and event maintenance process. The point redemption rules are also defined by functionality performed by the web site processor, i.e. the minimum number of points to be redeemed, increments of points which may be redeemed, etc. Bonus points and special point redemption offers may also be grouped into a promotion entity and the active dates of that promotion must also be defined within this application.

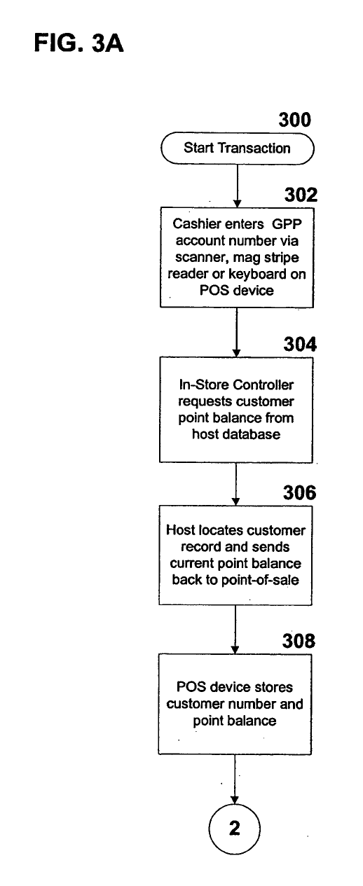

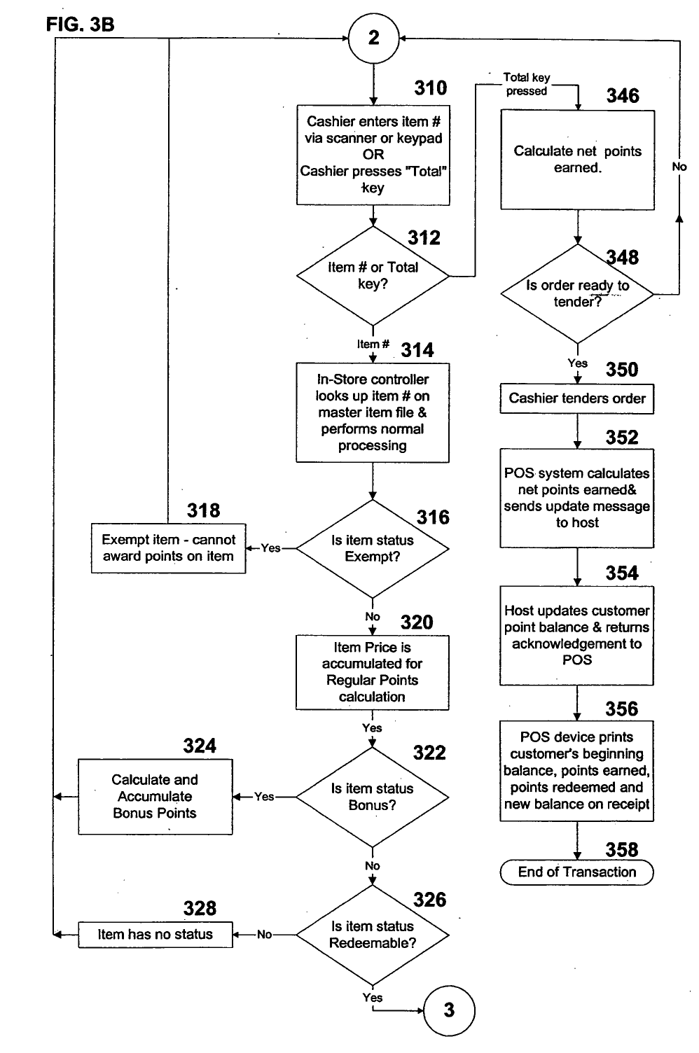

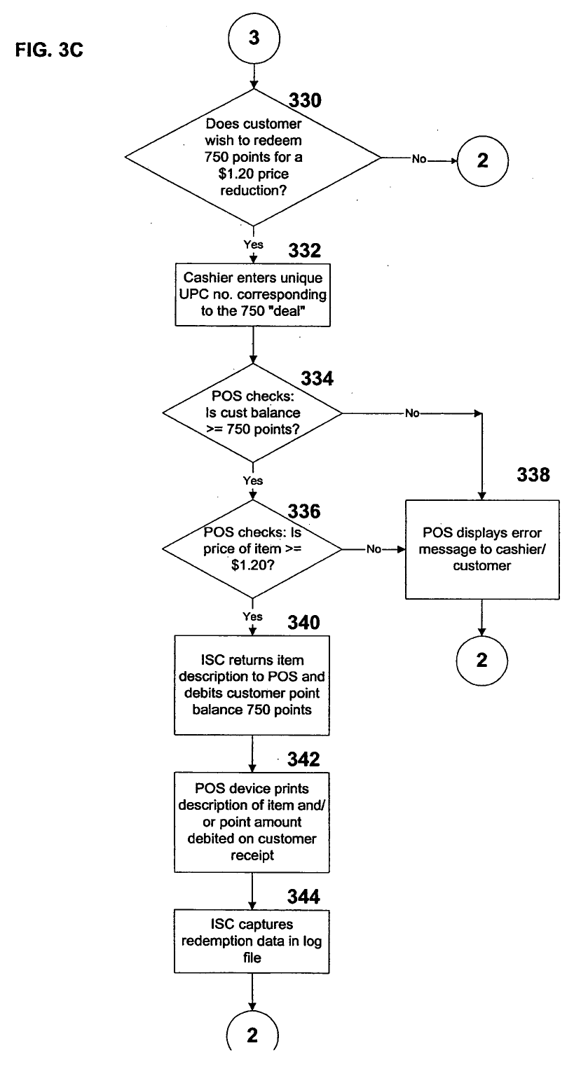

Referring to FIG. 3, an overview of an embodiment of the computer implemented transaction point accumulation system wherein both the internet and physical domain sides of the consumer transaction point accumulation system is shown, the physical processing illustrated is in two phased mode. In the physical domain, the point accumulation system's processing begins when a customer at the point-of-sale device for a retailer begins to purchase retailer products or services. At the start of the transaction 300, the retailer outlet cashier enters the customer's account number into the in-store system's point-of-sale device by way of a magnetic stripe card reader, keyboard or any other data input device used in conjunction with the point-of-sale device 302. Following input of the customer's account number, the in-store system controller 14 requests the customer's current point balance 304 from the host system 40 database 304. The host system 40 processes the request and locates a customer's account record stored within the host system 40 database and sends the account record back to the point-of-sale device 306 through the in-store system controller 14. The customer record that is sent back to the point-of-sale device 12 includes at least the customer's current accumulated point balance. The request for data by the in-store system 10 from the host system 40 and the transmission of customer account data from the host system 40 to the in-store system 10 both occur real-time so that the point-of-sale device 12 may save the customer's current accumulated point balance and account number in temporary data storage within the point-of-sale device 12 pending entry of a redeemable item 308. The customer point balance is also temporarily stored in the controller 14 so that points accumulated throughout the customer's transaction may be updated more quickly by updating the point balance being temporarily stored in the controller 14.

Following the capture of the customer's account record, referring to FIG. 3, the cashier enters an item number for an item being purchased by the customer via a scanner or keypad 310, 312 causing the point-of-sale device 12 to communicate with the system controller 14 requesting the controller 14 to look up the item number of the item being purchased on a master item file within the in-store system controller 14 database 314. All items of possible purchase should be stored in the master item file where they are cross referenced with an item number and a status label. The status label for each item stored within the in-store system database is either exempt, redeemable, bonus or no status. First, the system checks to see if the item the customer seeks to purchase has exempt status 316. If the status is exempt, no points can be awarded for the purchase of that particular item 318. The system then returns the point-of-sale device process back to the item entry state 310 so that the retailer may enter the item number of the next item desired to be purchased. If the item the customer seeks to purchase is not referenced as exempt, the point-of-sale device adds the price of the item to the accumulator tracking the eligible total for calculation of “regular” points 320. Next, the system checks to see if the item the customer seeks to purchase has bonus status 322. If the item being purchased has bonus status 324, the system processes the item being purchased as a bonus item and adds bonus points to the customer accumulated point balance total stored in temporary storage of the point of sale device. Next, the system returns the point-of-sale device process back to the item entry state 310 so that the retailer may enter the item number of the next item desired to be purchased.

If the item being purchased by a consumer does not have bonus status, the system checks to see if the item has redeemable status 326. If the item does not have redeemable status, it has no status 328 and the system returns the point-of-sale device process back to the item entry state 310 so that the retailer may enter the item number of the next item desired to be purchased. If the item has redeemable status, the system may notify the retailer of such status and prompt the cashier to ask the customer if he/she wishes to exchange points for a reduction in the price of the item purchased 330. In this embodiment, the customer may exchange 750 points for a $1.20 reduction in the price of the redeemable item being purchased. If the consumer declines to exchange points for $1.20 off the price of the redeemable item being purchased, the system returns the point-of-sale device process back to the item entry state 310 so that the retailer may enter the item number of the next item desired to be purchased. If the customer desires to exchange 750 points for a $1.20 reduction in the price of the item purchased 332, the cashier enters a unique code into the point-of-sale device corresponding to acceptance by the customer of the point exchange for a reduction in purchase price option. Following acceptance of the point exchange option by the customer, the point of sale device checks the balance of the customer's point total being temporarily stored in the point-of-sale device temporary data storage 334. Specifically, in this particular invention, the system is checking to see if the customer account point total is greater than or equal to 750 points. If the point total is less than 750 points 334, the point-of-sale device displays an error message to the retailer and voids out the 750 point exchange option 338 and the system returns the point-of-sale device process back to the item entry state 310 so that the retailer may enter the item number of the next item desired to be purchased. If the customer account point balance is greater than or equal to 750 points, the point-of-sale device checks the in-store system controller data base to determine if the price of the item being purchased is greater than or equal to $1.20 336. If the price of the item being purchased is less than $1.20, an error is displayed at the point-of-sale device to the retailer and the system returns the point-of-sale device process back to the item entry state 310 so that the clerk may enter the item number of the next item desired to be purchased 338. If the price of the item being purchased is greater than or equal to $1.20 340, the in-store system controller returns an item description to the point-of-sale device and debits the customer accumulated point balance temporarily stored in the point-of-sale device temporary storage by 750 points 340. The point-of-sale device prints a description of the item redeemed and/or the point amount debited from the consumer's accumulated account balance on the customer receipt 342. The in-store system controller also captures redemption and bonus data in a log file 344. Then, the system returns the point-of-sale device process back to the item entry state 310 so that the clerk may enter the item number of the next item desired to be purchased.

If all customer transaction items have been purchased, the retailer may press a total key 310, 312 in order to indicate that the customer's transaction is complete. Once the customer's transactions have been completed, the controller calculates the net points earned by the customer during the current sales visit 346. Next, the retailer determines whether the order is ready to tender 348. If the order is not ready to tender, the system allows for the return of the point-of-sale device process to the item entry state 310 so that the retailer may enter data necessary to tender the order. If the order is ready to tender, the retailer tenders the order 350 and the point-of-sale device calculates the total net points earned during the current sale's visit and the new account balance of points accumulated 352. The point of sale device also sends an update message to the host that includes the customer's points earned in the current transaction 352. The system host retrieves the point update transaction and returns an acknowledgment of receipt of the update message to the in-store system controller and point-of-sale device 354. In either the one-phased or two-phased mode, following receipt of a point update response message from the host system the point-of-sale device prints a receipt for the customer that includes the beginning point balance, the total points earned during the sales visit, the total points exchanged for price reductions during the sales visit and the new account point balance 356, which completes the transaction for that customer 358.

Referring to FIG. 4, the enrollment process at the on-line interactive web site is disclosed. Generally, the enrollment function is typically performed through the use of electronic forms on the interactive web site of the merchant, or on the loyalty program e-commerce web site of the program administrator host system. The customer accesses the electronic forms following selecting a display at the merchant web site or at the web site of the program administrator which indicates that the consumer would like to open a loyalty award account. Next, merchant web site user interface simply presents an electronic form, and prompts the consumer to enter the information requested on the form. Upon completion of the form, or if the consumer information was obtained from existing data, the data is transmitted to the program administrator host system, and checked against various edit rules for validity. If the data passes the edit checks, the program administrator host system creates a new account and assigns a unique account number to that account.

The enrollment function is initiated at the on-line interactive web site of the merchant or on the loyalty program e-commerce web site of the program administrator by selecting an icon identifying the enrollment option 400. Next, the server for the on-line interactive web site of the merchant or of the loyalty program e-commerce web site of the program administrator determines whether there is customer data available 402. If enrollment has been initiated through the on-line interactive web site of the merchant, and the customer has already provided name and demographic data to the electronic commerce merchant for billing and/or shipping purposes, that information can be retrieved from an existing merchant customer data base 416 and used to populate the fields of an electronic form automatically 404. If the customer has not previously provided name and demographic data to the electronic commerce merchant or if enrollment has been initiated through the loyalty program e-commerce web site of the program administrator, there is no customer data available for retrieval. The customer must enter the data in electronic forms provided by the on-line interactive web site of the merchant or by the web site of the program administrator 411. The data entered in the electronic forms must then be saved 412 and stored in a merchant customer database 413. Following automatic or manual completion of the electronic enrollment form, the enrollment data entered is sent to the program administrator host database 406, where the information is processed for errors 408. If there are enrollment errors 410, the customer is presented the electronic enrollment form 412 for additional data entry. If there were no enrollment errors, a new program account number is retrieved 414 from an account number database 418, thereby creating a new loyalty program account for a customer 420. The new account is maintained and stored in the customer database at the central host database system 424.

Creation of the new account triggers a card fulfillment process automatically implemented by the program administrator host system. This process physically extracts and matches a loyalty program card (typically plastic) 426 with the correct account number assigned to the customer. The card is inserted into a mailing piece with other program materials 428 and sent to the customer via the postal service 430. Successful creation of a new loyalty account also triggers an electronic response (email) to the customer confirming the information received and the account number 422. Next, the merchant web site processor or the program administrator loyalty program e-commerce web server processor returns the consumer to the calling homepage 432.

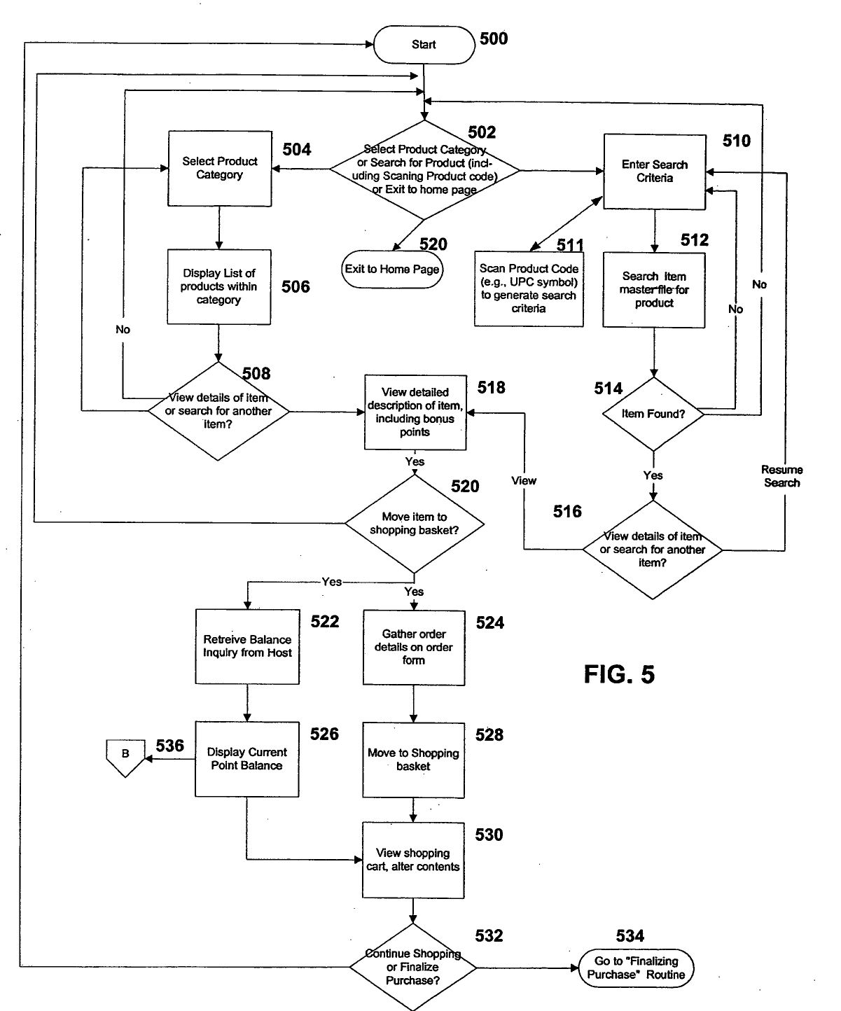

FIG. 5 illustrates an overview of the process flow of the product shopping, browsing and searching option functions provide for via a merchant on-line interactive web site. From the merchant web site homepage 500 a consumer is provided with the option of selecting a product by a plurality of methods 502, including selecting product categories, searching for products by keyword search or item number search, possibly using a scanner to help generate the search criteria by scanning the information off of bar-code or mag-stripe encoded entity for a known product. Selecting products by use of the select product category function 504 displays a list of products within a particular category and provides for the option of selecting one of the products from the list displayed to view the details 508 of the particular product. This function also allows for the consumer to perform an additional search for products by keyword or item number.

If the consumer chooses to search the interactive merchant web site by keyword or item number 510, the appropriate search criteria must be entered into the appropriate search field and transmitted. This can be facilitated by using a scanner to scan the information off of a bar-code or mag-stripe encoded entity for a known product in order to populate the search criteria fields using known information found on the scanned entity 511. The merchant web site processor searches an item master file for products satisfying the search criteria 512. If there is a match found for the search criteria 514, the merchant web site processor causes the information located to be displayed on the consumer's internet access device 514. The consumer has the option of selecting one of the products from the list of products located to view the product details 516. In addition to the items located, the consumer also has the ability to perform an additional search for products by keyword or item number or scanned product code.

If an item from the list of products that are displayed from a search by keyword or category is selected 518, the interactive web site displays a detailed description of the item, including bonus points that may be awarded upon purchase of the item to consumers participating in the loyalty program. If the consumer decides to purchase a product, the product will need to be moved into temporary data storage referred to as the “shopping cart” 520. Before items desired to be purchased can be moved into the “shopping cart”, an electronic “order form” may be displayed to gather the additional details of the order, such as quantity of items, size, color, etc. When the electronics order form is complete 524, the user interface provides an option, via a visual control, to move the designated items to the “shopping cart” 528. The “shopping cart” view displays the items currently placed in the “shopping cart”, along with pricing information 530. Bonus points are also attached to each item placed in the “shopping cart” and a running monetary cost subtotal may also maintained and displayed. The action of placing an item in the “shopping cart” may trigger an electronic point balance request to the program administrator host system, which in turn retrieves 522 and transmits the point balance back to the merchant web site where it is displayed to the consumer on his or her internet access device via the on-line interactive web site 526. Note that the balance inquiry function could be triggered by other events in the shopping process, such as when a category or brand is selected—the timing of the balance inquiry is not critical, as long as it is performed prior to the process being invoked to finalize the purchase. Note that this point balance would include any points earned at other participating partners in either the electronic commerce domain, or in the physical store domain. After the item has been moved to the “shopping cart” 528, the user is normally provided with the option to continue viewing the products available, view the contents of the “shopping cart” 530 and alter the content of the “shopping cart” 530. As the user continues to shop, the preferred embodiment displays the beginning point balance and a running summary of the total “bonus” points and “regular” points accumulated in the current transaction, and the projected new balance if the consumer purchases the items currently in the “shopping cart” 530. As the contents of the shopping cart are modified, the point information is updated to reflect those changes.

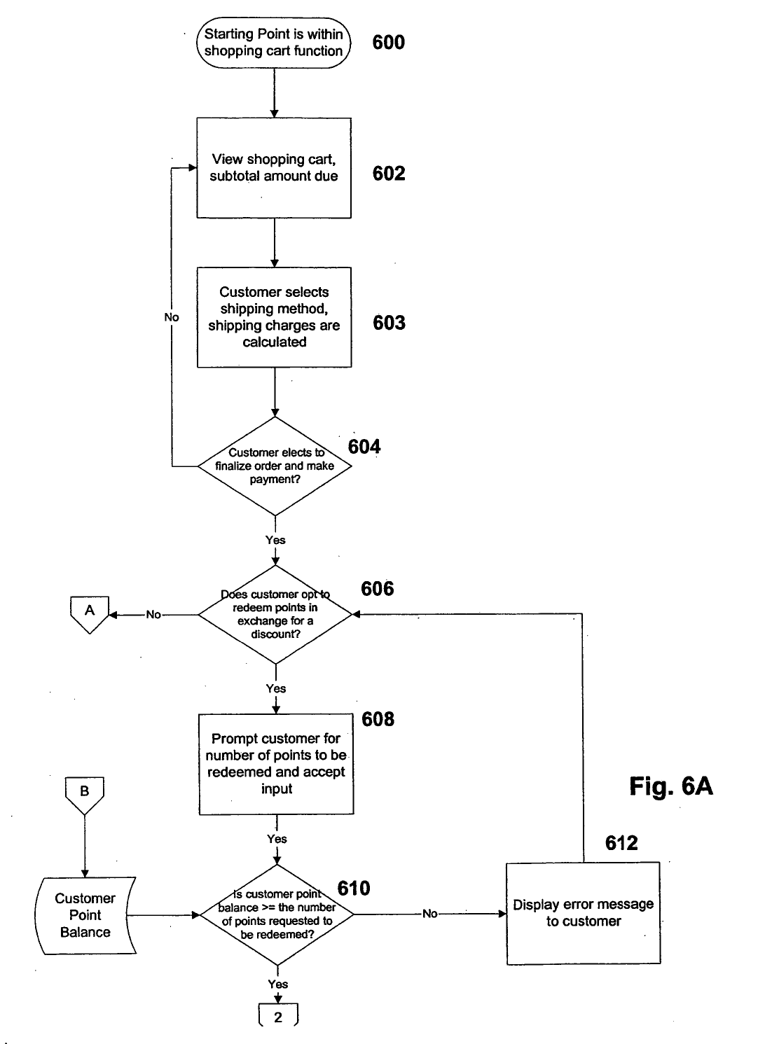

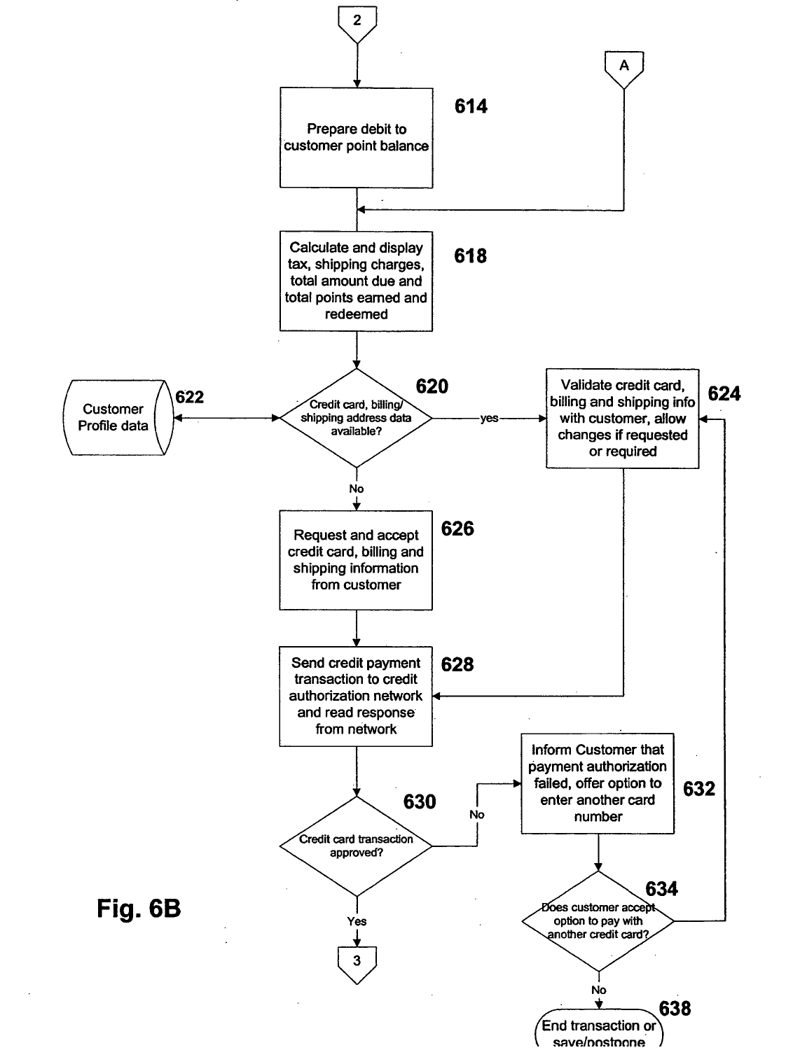

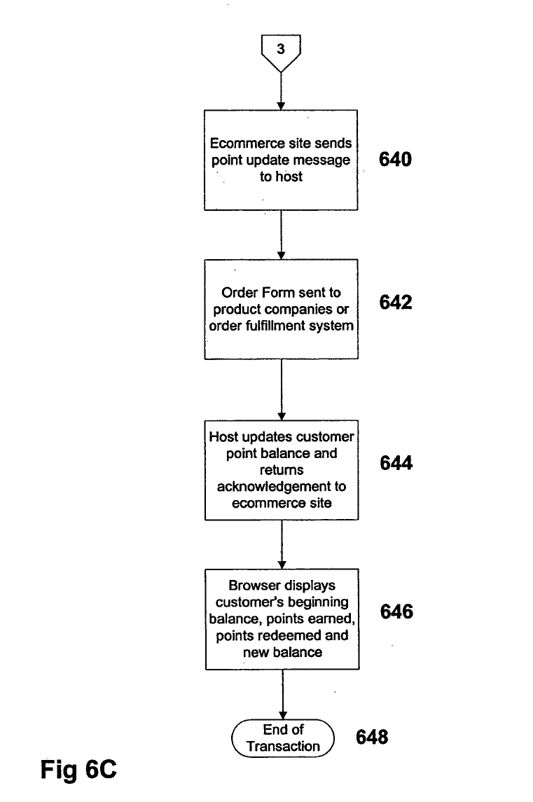

Upon completion of shopping 532, the user elects to finalize the purchase and engages a finalization of purchase routine 534 that calculates and displays the total monetary amount due. The total amount due may or may not include sales tax due and shipping charges. A summary of total points earned in the order is also displayed. In one embodiment of the finalization of purchase routine, illustrated in detail in FIG. 6, it begins within the shopping cart function 600. First, the user is provided with an opportunity to view the items identified for the shopping cart and the subtotal of the amount due 602. Next, the customer selects the shipping method and the shipping charges are calculated and displayed. If the customer indicates that they want to continue finalizing the order and make payment 604, the system queries the user whether they would like to redeem points in exchange for a discount on the purchase 606. If the customer indicates that they are not ready to finalize the order and make payment, the user is again provided with an opportunity to view the items identified for the shopping cart and the subtotal of the amount due 602. If the customer opts to redeem points in exchange for a discount 606, the customer is prompted to enter the number of points to be redeemed and to initiate the redemption process 608. If the customer point balance is less than the number of points requested to be redeemed 610, an error message is displayed to the customer and the routine reinitiates the query to the customer as to whether they would like to redeem points in exchange for a discount on the purchase 606. If the point balance is greater than or equal to the number of points requested to be redeemed 610, the system prepares a debit command to the host database system to debit the customer point balance by the amount of points indicated and reduce the total amount due by the appropriate amount. Next, the tax, shipping charges, total amount due, total points earned and redeemed are calculated and displayed 618. Next the system queries its customer profile database 622 to determine if the customer's credit card, billing/shipping address information is available 620. If the customer's credit card and billing/shipping address information is not available, the system requests and accepts the credit card and billing information from the customer 626. If the customer's credit card and billing/shipping address information is available 620, it is retrieved from the customer profile database and validated by the customer 624. At this step in the process, the customer is allowed to make changes to the customer data retrieved if required. After the credit card, billing/shipping information has been entered 624, 626, a credit payment transaction is initiated and sent to the credit authorization network 628. The customer is also provided with a response from the credit authorization network. If the credit card transaction is not approved 630, the customer is informed that payment authorization failed 632. The customer is then provided with an option to enter another credit card number 632. If the customer does not accept the option to pay with another credit card 634, the contents in the shopping basket are stored temporarily so that the customer may re-engage the transaction at a later date. Next, the transaction is terminated. If the customer enters and alternative credit card number 632 and accepts the option to pay with alternative credit card 634, that new credit card number is displayed along with the other billing and shipping information to the customer so that its accuracy can be validated 624. The system them steps through the same processing steps set forth above following validation of credit card information.

If the credit card transaction is approved 630 the merchant web site processor transmits the updated consumer point transaction, including both the number of points to be debited and points to be credited to the program administrator host system 640. Next, the merchant web site processor automatically transmits the product order electronically to the order fulfillment entity, which could be an internal or external system 542. The merchant web site processor in conjunction with order processing system also manages and monitors the merchandise fulfillment process throughout the lifecycle of that process. The program administrator host system updates the consumer account information with the updated point balance and consumer information and returns and acknowledgement back to the interactive homepage 544. The interactive web site homepage may then display the customer's beginning balance, points earned, points redeemed and the new updated point balance following the transaction 646. The transaction is then concluded 648. At the time the consumer account information stored in the program administrator's host system central database is updated with this information, the points and all other consumer account information is immediately available to all other retailer systems networked to the program administrator host system in both the physical and internet domains.

An additional feature of the preferred embodiment of the present invention facilitates manufacturer participation in the loyalty program marketing feature in both the physical and internet domains. The feature allows manufacturers to promote products in both the physical and internet domains by providing coupons in products in the physical domain, wherein the coupons are redeemable only in the internet domain. Coupons having unique loyalty reward coupon numbers that have loyalty bonus points associated therewith are packed into products sold in the physical domain. The coupons are packed into a manufacturer's product so that awards associated with the coupon number provided may be redeemed by customers that purchase specific products. Each coupon packed into the products has a unique loyalty reward coupon identification data that has loyalty bonus points associated therewith, which may optionally appear encoded in the form of a bar-code or other machine-readable code on the coupon. The loyalty points associated with the unique loyalty reward coupon number may be retrieved and posted in a customers loyalty program account via the internet domain at an interactive web site.

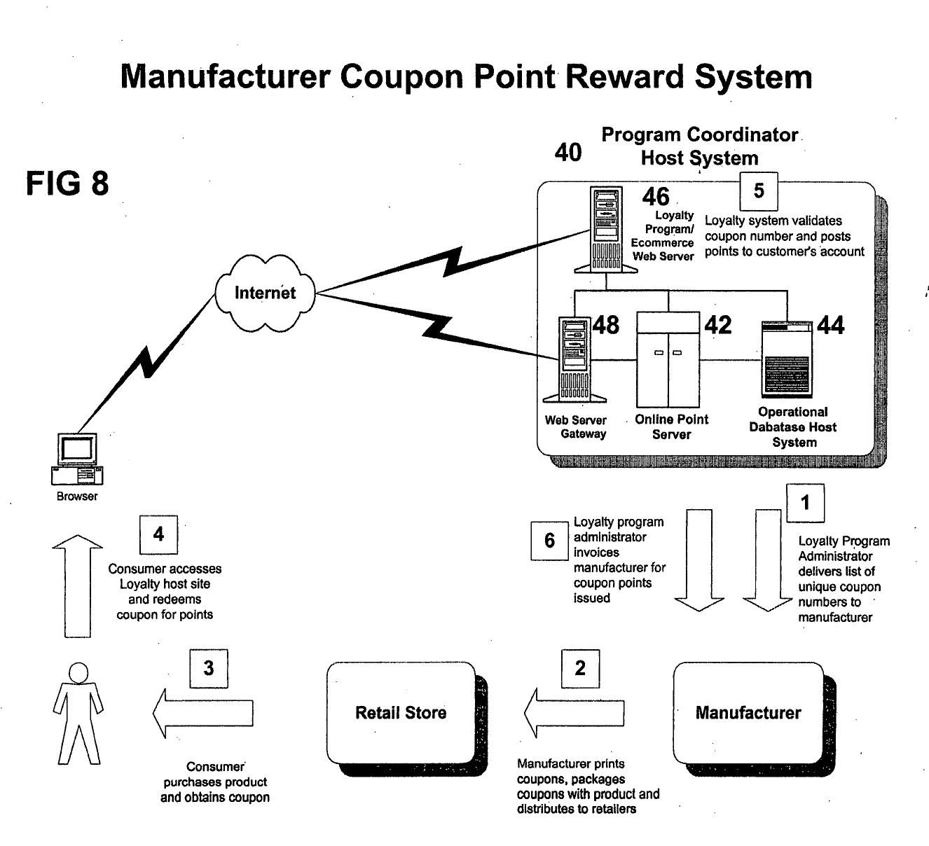

Referring to FIG. 8, initially, the loyalty program administrator generates a list of unique loyalty reward coupon numbers, step 1, and provides a participating manufacturer with a copy of that list. The list of unique loyalty reward coupon numbers may be communicated in a number of ways, preferably, the list would be transferred to the manufacturer electronically. Step 2, from the list of unique loyalty reward coupon numbers, the manufacturer can generate coupons having the unique loyalty reward coupon numbers and any other marketing information thereon that the manufacturer would like to present to the consumer. These coupons are packed into specific products that a manufacturer may be trying to promote.

The loyalty program administrator stores the unique loyalty reward coupon numbers generated into a direct access storage device or temporary memory at the program administrator's central database host system 46. Each loyalty reward coupon number has an associated bonus point value, status code that describes the condition of the coupon, and a manufacturer code identifying the manufacturer distributing that coupon. The status code is used to prevent fraudulent redemption of the coupons.

Initially, upon generation of a loyalty reward coupon number, the status code identifies each newly generated loyalty reward coupon number stored in the host system as “N” not distributed. Upon distribution of a unique loyalty reward coupon number to a manufacturer for use, step 1, the status code associated with that loyalty reward coupon number is flagged as “D” distributed. A loyalty reward coupon number identified as distributed “D” is eligible for redemption. Loyalty reward coupon numbers that are not identified as distributed “D” are not eligible for redemption. When a coupon is redeemed by a consumer, steps 4 & 5, the status flag associated with that coupon number is changed to “R” on the program administrator central database host system 46. The “R” represents that the points associated with the coupon that are issued to (or awarded to) the consumer loyalty account and may be redeemed. The status flags associated with each loyalty reward coupon number assists with assuring that manufacturer coupons are used only once for the number of bonus points previously assigned to that particular coupon number.

Step 2, the loyalty reward coupon numbers provided to the manufacturer by the loyalty program administrator are affixed to the product packaging or printed on a coupon that is included within the packaged goods. The coupon may also include instructions directing the consumer to the internet web site where the coupon may be converted to loyalty bonus points. The instructions further provide directions to the product purchaser on the steps required to redeem those points and have them posted in the consumer's account. The coupon may also include a scannable version of the coupon number that can be scanned by a scanning device.

After the consumer purchases a product and accesses the coupon, step 3, the coupon directs them to log onto the program administrator's web site at which the consumer may enter their loyalty program account number and the coupon number, step 4, optionally using a scanner to scan their loyalty program identification card, which is also used in-store to identify them. Following entry of the consumer and coupon information, the host system 40 processes the information, step 5, validating the coupon number for validity and to avoid fraudulent use of a coupon, posting points to the consumer's account for valid coupons. Periodically, step 6, the Loyalty program administrator invoices the manufacturer for coupon points issuance based on redeemed coupons. In such an embodiment, the invoicing of the manufacturer is based on the actual coupons that are redeemed by a consumer. In an alternative embodiment, the Loyalty program administration could invoice the manufacturer following step 1, immediately upon issuance of the coupon, thus invoicing the manufacturer regardless of the specific coupons that are actually redeemed. It is to be understood that these are two methods of determining when the manufacturer is invoiced, and the step of creating and sending the invoice is not to be limited to any specific point in time or step in the process.

If the consumer accessing the program administrator's web site does not enter their loyalty program account number, or does not have a loyalty program account number, an option to enroll in the loyalty program and obtain an account number is offered to the consumer. The enrollment function is initiated at the on-line interactive web site of the program administrator by selecting an icon identifying the enrollment option 400, referring to FIG. 4. The program administrator's web site user interface simply presents an electronic form 411, and prompts the consumer to enter the information requested on the form. Upon completion of the form, the data is transmitted to the program administrator 406, and checked against various edit rules for validity 408. If the data passes the edit checks 410, the central data base host system creates a new account and assigns a unique account number to that consumer 414. Creation of the new account triggers the card fulfillment process implemented by the program administrator.

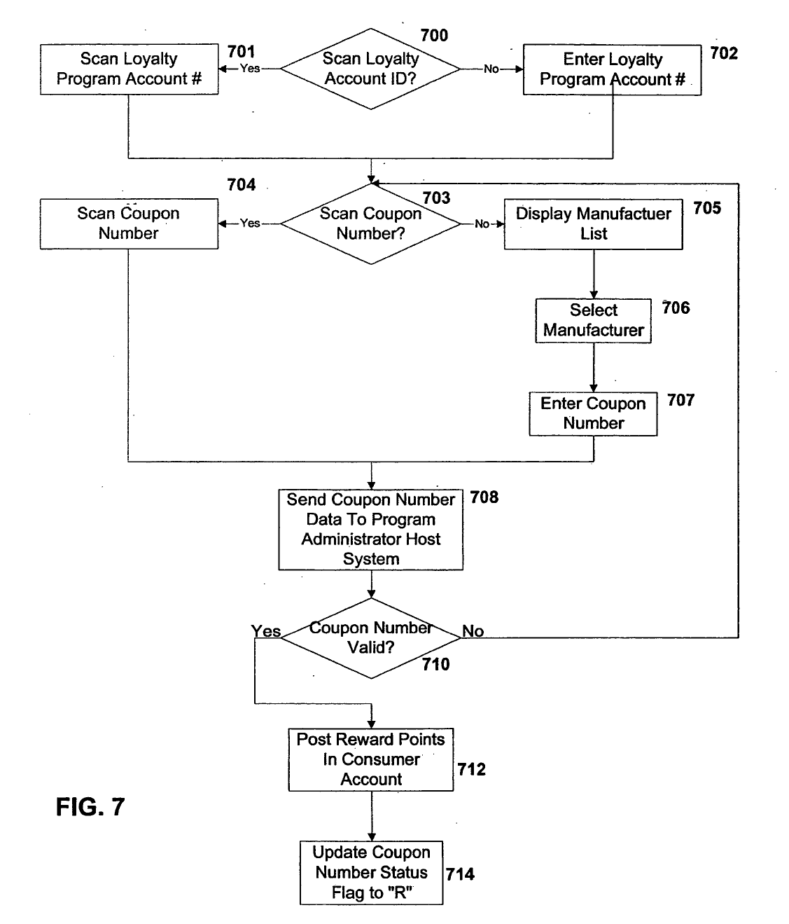

Referring to FIG. 7, consumer's that have a loyalty program account number enter the account number in the appropriate field at the appropriate page within the program administrator's interactive web site 700, either manually entering the consumer's loyalty program account number 702 or optionally making use of a scanning device to scan the loyalty program identification card containing the consumer's identification number 701. The entry of a valid loyalty program account number provides the consumer access to a plurality of additional interactive web site pages within the program administrator's web site, one of which is used to enter the coupon numbers of the coupons the consumer wishes to redeem. This can be done using a scanner 704 or manually, by first viewing a list of manufactures participating in the program 705, then selecting the appropriate manufacturer 706, and then entering the consumer's unique loyalty reward coupon number that the consumer received off the packaging of the product purchased or off of the coupon enclosed within the product packaging 707. Once the unique loyalty reward coupon number has been entered, a transaction is formatted by the web site processor and transmitted to the central database host system 708, where the coupon number is validated 710 and the award points associated with the loyalty reward coupon number are posted to the customer's account 712. The transaction also modifies the status flag associated with the loyalty program coupon number to “R”, representing that the points have been posted, so that the loyalty program account number cannot be used a second time 714. The program administrator host system also inputs the coupon redemption data into an invoicing system so that the manufacturer can be billed by the program administrator for the points posted in the consumer account. The points resulting from coupon redemption are immediately posted following entry of the coupon number into the system, and the points are thereby immediately available for use and can be viewed and/or redeemed at any one of the plurality of participating retailer systems networked to the host incentive award system. Because the participating retailer systems include in-store systems and on-line interactive web sites, redemption of points posted can be used immediately in the physical and internet domain to reduce the price on select items purchased by the consumer.

The present invention provides for the program administration web site to provide a customized experience to each consumer. When the consumer enters his or her account number, the system evaluates the consumer's buying history as represented in the product purchase data stored in the database. This data is cross-referenced against the then-currently defined promotionals to see which promotional offers match the consumer based on buying habits. The result of this comparison is the set of most applicable advertising for the specific consumer, and can be used to customize the consumer's experience, thus providing a “market segment of 1” capable marketing system that provides the most relevant promotional offers to each consumer.

The comparison algorithm includes, without limitation, the following. For promotions that require the purchase of X items, X>1, the system determines how close to the reward the consumer is, and encourages the consumer as X-Y purchases are made to “purchase Y more of the product” to receive the award. If demographic analysis has indicated that consumers who have purchased product A or a set of products A1, A2, A3 have a proclivity to purchase product B or a set of products B1, B2, it can offer promotions designed to encourage consumers to try products B or B1, B2 after the system recognizes purchases of A or A1, A2, A3. Using such an approach of highlighting relevant offers to each consumer based on their individual buying habits and history, the current invention promotes more comprehensive customer loyalty to product retailers and manufacturers by specifically bringing relevant promotions to the consumer's attention based on analysis of the consumer's history of purchasing.

Although the operation of an embodiment of the computer implemented consumer transaction point accumulation system has been disclosed, alternative embodiments of the invention can be made without the departing from the spit and scope of the invention. It should be appreciated and understood that the invention resides in the claims hereinafter appended.

1. A point reward method for manufacturer coupons, comprising:
providing lists of unique coupon identification data to a plurality of product manufacturers;
distributing products with printed coupons corresponding to the unique identification data packaged therewith;
reading identification data of coupons of products purchased by consumers with data reading devices which can be associated with individual consumer internet access devices;
transmitting consumer identification data and coupon identification data from consumers'internet access devices to a point host system;
validating the coupon identification data and awarding points to accounts for the identified consumers; and
billing the product manufacturers based on points awarded corresponding to the unique identification data coupons.
